(19) United States
(12) Patent Application Publication
(10) Pub. No.: US 2017/0072413 A1
(43) Pub. Date: Mar. 16, 2017

(54) EXTENSION DEVICE FOR SPRAYING DEVICES AND SPRAYING DEVICE

(71) Applicant: Krautzberger GmbH, Eltville (DE)

(72) Inventor: Thomas Weidmann, Bettendorf (DE)

(21) Appl. No.: 15/122,970

(22) PCT Filed: Mar. 3, 2015
(86) PCT No.: PCT/EP2015/054366

§ 371 Date: Sep. 1, 2016

(30) Foreign Application Priority Data
Mar. 5, 2014 (DE) 10 2014 204 012.4

(51) Int. Cl. B05B 1/30; B05B 15/06; F16K 31/46; B05B 7/06

(52) U.S. Cl. CPC B05B 1/304; B05B 1/308; B05B 7/066; B05B 15/066; F16K 31/465

(57) ABSTRACT

An extension device for spraying devices has an extension unit, which has, at a first end, a spraying head having at least one material outlet nozzle and, at a second end, means for connecting a spraying device. The extension device is characterized in that the extension unit has a metering and shut-off valve, which has a valve seat element having a valve opening and which has a valve body, that the valve body is arranged between the spraying head and the valve seat element, and that the valve body is fastened to a tension-transmitting element, which extends through the valve opening. The invention further relates to a spraying device for spraying material onto surfaces, with the spraying device having such an extension device.

### CROSS REFERENCE TO RELATED APPLICATION

The present application claims the priority benefits of International Patent Application No. PCT/EP2015/054366, filed Mar. 3, 2015, and claims benefit of DE 102014204012.4, which are hereby incorporated herein by reference in their entirities.

### BACKGROUND OF THE INVENTION

The present invention relates to an extension device for spraying devices with an extension unit, exhibiting a spray head with at least one material discharge nozzle at a first end and at its second end means to connect a spraying device. In addition, the present invention relates to a spraying device to spray material onto surfaces with an extension device.

Spraying devices have been state of the art for a long time and are used in many different areas for the purpose of cleaning, disinfection, surface treatment or coating workpieces. The main structure of the spraying devices is essentially comprised of a base body with valves for the material to be sprayed, a material needle, a spray head with a material discharge nozzle, and possibly air nozzles, as well as an actuator to activate and terminate the spraying process.

The materials to be sprayed are understood to be both liquid as well as paste-like media. Both highly as well as low-viscous spray material may be utilized.

In order to adapt the diverse applications of the spraying devices to the different geometries and properties of workpieces, a number of adapters or extension devices are known to be positioned between the spray head and the base body of the spraying device.

For example, an extension device with a rigid, straight spraying tube, also identified as a spray lance, is used for spraying trees, shrubs or the like as well as for industrial purposes, and is known from patent DE 1 005 783. The spray head of the jet tube is comprised of nozzles with valves, which are positioned with their valve plates ahead of the inlet openings of the nozzles. By rotating a rotatable body, the different nozzles located in the spray head can be controlled, whereby it is possible to adjust to different spraying modes. The side of the jet tube opposite the spray head can be mounted on the base body of the spraying device.

A spray lance for a high-pressure cleaning device, wherein the spray lance is comprised of a hose with a nozzle and a support member, on which the hose is attached, is known from DE 20 2004 018 903 U1. Another embodiment provides a rigid tube, wherein the nozzle is positioned in a pivotable manner around a pivot axis transverse to its main spraying direction, specifically however, transverse to the longitudinal direction of the spray lance or the handle, instead of the hose.

An extension device, which includes an extension tube, exhibiting its own control with hose connections at one end and a spray head with a material discharge nozzle on the other end, is known from DE 100 56 040 A1. The spray head comprises a material needle, which is controlled by means of compressed air and can be used to open and close the material discharge nozzle. Adjacent to the material discharge nozzle, nozzle horns with air nozzles are located on the spray head. The spray head is connected to the control device with the hoses located on the inside of the extension tube.

This extension device has the disadvantage that an additional control device is required, particularly to actuate the material needle located in the spray head, and that the mechanical actuator usually located in the spraying device cannot be used directly.

Furthermore, the spray head is clearly designed more elaborately due to the compressed air actuator means for the material needle. The manufacturing cost of the extension device is therefore overall more expensive than for extension devices, in which the material needle is guided from the spraying device to the material discharge nozzle through the extension tube.

For example, such a device is known from DE-PS 585239. The spray head is constructed more plainly than with DE 100 56 040 A1, however, the length of the extension device is limited due to several factors.

The material needle extending the entire length of the extension tube increases the total weight of the extension device, so that extension devices of several meters in length are no longer manageable. With such large lengths, the material needle will buckle and must be provided with additional support as necessary in the extension tube, not only further increasing weight, but also manufacturing cost.

Another disadvantage lies therein that angled extension devices, for example, cannot be implemented without accepting additional disadvantages. The rigid material needle can be guided from the spraying device only to the bend in the extension tube, where another nozzle must then be positioned, with which the material needle interacts. Between this nozzle and the spray head positioned at the front end of the extension device, where the material exits through the actual material discharge nozzle, is potentially a large volume in the extension tube. After closing the nozzle by means of the material needle, material remains in this volume, which may discharge unintentionally through the constantly open material discharge nozzle.

### SUMMARY OF THE INVENTION

It is an object of the invention to provide an extension device, which distinguishes itself by a low weight and simple structure even at great lengths, wherein the amount of material to be sprayed, which may leak unintentionally, is to be minimized.

The extension device is characterized in that the extension unit is comprised of a metering and shut-off valve exhibiting a valve seat member with a valve opening and a valve body, that the valve body is positioned between the spray head and the valve seat member and that the valve body is fastened to a tension-transmitting member, which extends through the valve opening.

The metering and shut-off valve is preferably positioned within the extension unit, preferably in the first end of the extension unit or at the first end of the extension unit.

The valve body is preferably located in front of the material discharge nozzle of the spray head.

The valve body may extend into the spray head. The valve body does not interact with the material discharge nozzle.

The metering and shut-off valve is preferably positioned in front of the spray head and thus in the flow direction of the material before the material discharge nozzle.

Positioning the metering and shut-off valve as closely as possible in front of the spray head, respectively in front of the material discharge nozzle of the spray head, has the advantage that the space between the metering and shut-off valve and the material discharge nozzle can be kept small. The loss of material, respectively the remaining material, is therefore reduced considerably.

If the metering and shut-off valve is positioned at the first end of the extension unit, the spray head is positioned at the first end of the extension unit and/or at the metering and shut-off valve.

The metering and shut-off valve exhibits a valve seat member with a valve opening in interaction with a valve body. The conventional rigid material needle is replaced by the valve body and a tension-transmitting member attached thereto, wherein the valve body is located between the spray head and the valve seat member. The valve body is thus located between the material discharge nozzle and the valve opening.

This arrangement is advantageous in that the pressure of the material to be sprayed can be used to open the metering and shut-off valve. The material pressed through the valve opening moves the valve body from the valve opening in the direction of material discharge nozzle, whereby the valve opening is opened. In order to close the valve opening, the valve body is pulled into the opposite direction by means of the tension-transmitting member. As the tension-transmitting member is required only to close the metering and shut-off valve, but not to open the metering and shut-off valve, it must not be rigidly constructed like a conventional material needle. This opens up the possibility for a simpler and particularly more flexibly designed tension-transmitting member, so that the extension unit can also be designed curved or bent.

When retracting the valve body, the valve body moves increasingly closer to the valve seat member and finally closes the valve opening completely. Depending on the design of the metering and shut-off valve, the effective inner diameter of the throttle and shut-off valve may be altered by means of the tension-transmitting member by even slightly moving the valve body to the valve seat member, whereby the material flow can be controlled. As the tension-transmitting member is guided by the valve opening, the valve body is automatically pulled in front of the valve opening during the closing process, so that a tight seal is always guaranteed.

In order to ensure that the spray material passes through the valve opening, the cross-section of the valve opening is greater than the cross-section of the tension-transmitting member.

Opening the valve is accomplished by releasing or suspending the tractive forces acting on the tension-transmitting member. Due to the material pressure of the material located inside the extension device between the second end of the extension unit and the metering and shut-off valve, the valve body is pushed out of the valve seat member in the direction of the first end of the extension unit or pushed away from the valve seat member. The valve body is pushed as far in the direction of the first end of the extension unit as is possible with the maximum length of the tension-transmitting member.

The tension-transmitting member can preferably be connected with a spraying device actuator located in the spraying device, which has the advantage that this device is utilized and additional actuators in the spray head, as is the case with state of the art according to DE 100 56 040 A1, are dispensable. The structure of the extension device is therefore further simplified, and manufacturing costs are kept low.

Due to this connectivity, the tension-transmitting member can be comfortably operated via the spraying device. The actuator thus transfers tractive forces by means of the tension-transmitting member to the valve body. In addition, this connectivity offers the possibility of equipping a spraying device with various extension devices. Furthermore, a respective exchange of the extension device can be performed very quickly and inexpensively.

In order to also transfer these tractive forces reliably, the tension-transmitting member is preferably soldered, welded or glued to the valve body. The connection may also be accomplished by means of clamping.

The tension-transmitting member preferably consists of flexible material.

The tension-transmitting member may also, for example, consist of a rope, cable, wire or a chain.

The tension-transmitting member may exhibit significantly lower material cross-sections than is the case with a conventional material needle, as the tension-transmitting member is subjected to tensile stress only during tension. This has the advantage that weight is saved and that extension devices, exhibiting a length of several meters, are still manageable. The extension unit preferably exhibits a length of at least 0.5 m, specifically at least 1 m or at least 2 m. The extension unit may exhibit a length of 5 m or even up to 10 m.

The tension-transmitting member enables force transmission between the second end of the extension unit and the valve body, regardless of the shape of the extension unit, i.e. regardless whether the extension unit exhibits curves, or is constructed straight.

A flexible, i.e. bendable, tension-transmitting member adapts to any form of extension unit without being limited in its function. In order to be able to ensure the function of the tension-transmitting member pulling the valve body in the axial direction of the extension unit in the direction of the second end of the extension unit, its flexibility must not apply to the axial direction of the extension unit.

By using, for example, a cable or rope, the flexibility of the tension-transmitting member can be accomplished in a simple, inexpensive and practical manner. Furthermore, it is very easy to lay a rope or cable through the extension unit of the extension device, specifically if the extension unit exhibits curvatures.

The tension-transmitting member consists advantageously at least partially of metal or an alloy or plastic, or a combination thereof.

Tension-transmitting members made from these materials exhibit good flexibility in the radial direction and very little flexibility in the axial direction depending on their diameter and are therefore very suitable for the transmission of tractive forces. In addition, by selecting different materials, the tension-transmitting member can be adapted to the respective requirements. For example, metals or alloys exhibit increased long-term stability, while plastics may be resistant to acidic or alkaline spray materials.

In another advantageous embodiment of the extension device according to the invention, the extension unit is at least partially curved.

The degree of curvature may be chosen arbitrarily. The extension unit may have only one curvature or even several curvatures that are provided consecutively. The term curvature here means any deviation from a straight line.

By means of an extension unit with at least partial curvature, the extension device can be adapted to different workpieces to be treated. By selecting appropriate curvatures, even undercuts or cavities of workpieces can be reached with the first end of the extension unit and be treated or coated with spray material. Due to the flexibility of the tension-transmitting member, the tension-transmitting member accordingly aligns with the respective curvatures of the extension unit.

The extension unit preferably consists of a pliable, preferably ductile material, and/or the extension unit is comprised of at least one pliable section. Ductile material can be metals, alloys or plastics. Pliable sections can be positioned between non-pliable sections. Such pliable sections may consist of pliable materials or even of a bellows-like structure. At the curved location, such bellows-like or accordion-like sections are preferably dimensionally stabile, specifically dimensionally stabile as it pertains to their diameter.

In a first embodiment, the valve seat member is an annular disc and the valve body a valve plate.

Annular discs and valve plates are inexpensive workpieces, which, in addition, can be easily positioned in the extension unit.

An annular disc can be made with different opening diameters, which, in addition, can be positioned centrally or peripherally inside the annular disc. By using an annular disc as the valve seat member, the option of adapting same to the different requirement features of the extension device is therefore attained.

According to a further embodiment, the valve seat member and the valve body each exhibit a cone-like or frustoconical shape.

A cone-like or frustoconical valve body, whose cross-section tapers in the direction of the second end of the extension unit, is a streamlined valve body. So configured, turbulences of the spray material flowing past the valve body are greatly reduced. Thus a homogenous and constant material discharge from the first end of the extension device is ensured.

The valve seat member preferably exhibits a first conical surface and the valve body a second conical surface. The conical surfaces are adapted to each other such that the valve body in the closed position abuts with its second conical surface against the first conical surface. Outside of a good seal in the closed position of the valve body, the valve body is centered by the interaction of the conical surfaces during the closing process. A tilting of the valve body is thereby prevented.

In one advantageous embodiment, the valve body is at least partially comprised of metal or an alloy or plastic, or a combination of these materials.

As already described in the context of material properties of the tension-transmitting member, the valve body can also be adapted to different requirement profiles of the extension device by selecting different materials. For example, valve bodies made of metal exhibit an increased lifespan, while valve bodies made of plastic are more cost-effective and lighter.

In another advantageous embodiment, the extension device exhibits at least one hole and/or at least one groove. These grooves and holes preferably extend in the longitudinal direction of the extension unit. Holes and/or grooves have the advantage that when the valve body is in the open position, space is created for spray material to pass through.

The outer cross-sectional dimensions of the valve body can be adapted to the dimensions of the inner cross-section of the extension unit such that the valve body is guided inside the extension unit. In this embodiment, while the valve body is in the open position, the spray material flows exclusively through the holes and/or grooves, whereby the grooves are preferably positioned in the outer circumferential surface of the valve body.

The outer cross-sectional dimensions of the valve body may be lower than the dimensions of the inner cross-section of the extension unit. In this embodiment, the valve body is not guided, however there is an advantage in that sufficient space is available between the valve body and the wall of the extension unit to allow spray material to pass. The holes and/or grooves form an additional space for the spray material to pass, which is specifically important in the use of highly viscous materials.

Holes and/or grooves have an additional advantage in that the volume flow of the spray material intended to pass through the valve opening can be additionally adjusted. Also, the risks of possibly occurring clogs at the throttle and shut-off valve are reduced by providing holes or grooves.

A material guide element is preferably positioned in front of the valve opening in the direction of the flow of the material to be sprayed. The material guide element directs the material flow to the valve opening, whereby dead spaces are avoided in the area in front of the metering and shut-off valve, and the flow of the material is promoted. The material guide element is preferably an integral component of the valve seat member.

The material guide element is preferably shaped in a frustoconical manner or has a conical inner surface. Thus, a conical cavity is formed in the material guide element, tapering toward the valve opening.

In an advantageous embodiment of the extension device, the extension unit is a tube.

An extension unit made as a tube is cost efficient and can be made fast. Tubes may exhibit different wall thicknesses, diameters and cross-sections, whereby the extension unit can be adapted to many different spray materials and workpieces to be treated. The tube preferably exhibits a circular cross-section, whereby non-rotational passage of the spray material through the extension unit is promoted.

Preferably at least one compressed air line, which can be positioned inside or outside of the extension unit, is provided.

In order to form a beam, the spray head exhibits at least one air nozzle, which can be connected to the compressed air line.

The extension unit is preferably made with double walls. The extension unit preferably exhibits an inner and an outer wall.

The inner wall and the outer wall are preferably positioned at least partially spaced apart from each other, specifically completely spaced apart, so that a compressed air line is formed. To completely space apart walls means that the walls are positioned spaced apart over the entire length of the extension unit.

The inner wall and the outer wall are preferably positioned coaxially.

The outer wall is preferably a hose. A hose has the advantage that it can easily be pushed via the wall of the extension unit. Partial contact of the hose with the wall cannot be excluded with curved extension units. In this instance, partially spaced positioning of the two walls is the case.

The invention also relates to a spraying device for spraying spray materials onto surfaces, whereby an extension device according to the invention is provided.

This spraying device exhibits the same advantages previously discussed in the context with the extension device according to the invention.

In an advantageous embodiment of the spraying device, the actuator is connected to the tension-transmitting member of the extension device.

In another advantageous embodiment of the spraying device, the actuator exhibits a movable plunger and a spring device. This plunger is preferably positioned in a manner accommodating retracting and extending. The tension-transmitting member is preferably attached to the plunger.

### BRIEF DESCRIPTION OF THE DRAWINGS

FIGS. 1a, b Sectional illustrations of the extension unit with a spraying device according to a first embodiment with a metering and shut-off valve in open and closed positions,

FIG. 2 an extension unit with a spraying device according to a second embodiment,

FIG. 3a-c enlarged sectional illustrations of the first end of an extension unit with metering and shut-off valves according to three additional embodiments,

FIG. 4 a sectional illustration of an extension unit with a spraying device and a metering and shut-off valve according to FIG. 1a, b and a spray head according to another embodiment,

FIG. 5 a sectional illustration of an extension device with a spraying device according to another embodiment and

FIG. 6 a detailed illustration of the first end of the extension unit according to FIG. 5.

### DESCRIPTION OF THE PREFERRED EMBODIMENTS

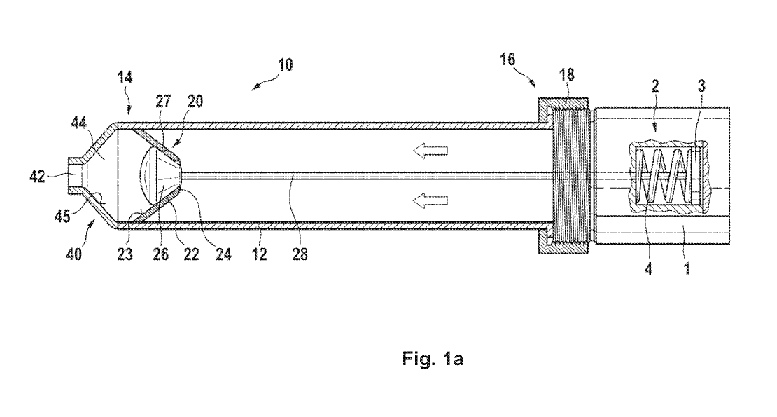

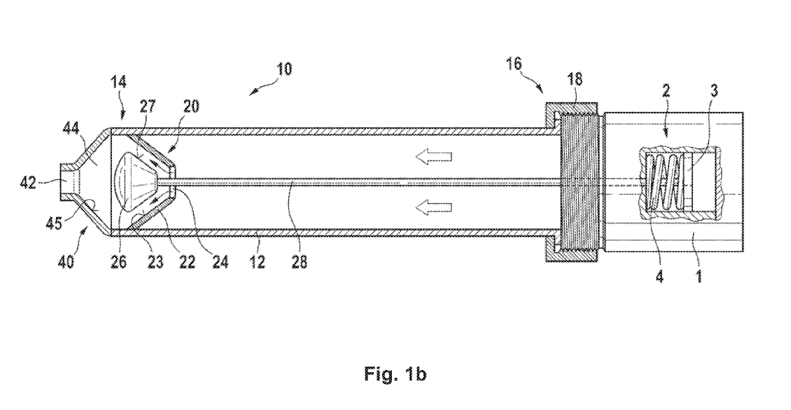

FIG. 1a is an extension device 10 shown in longitudinal section, connected at its second end 16 to spraying device 1 by means of fastening devices 18, which may, for example, exhibit a screw thread. Spraying device 1 is depicted schematically in FIG. 1.

At its first end 14, extension unit 12 shows a spray head 40, which exhibits a material discharge nozzle 42. The embodiment shown here shows spray head 40 shaped cone-like and exhibiting a conical inner surface 45. Spray head 40 may be attached to extension unit 12 in a releasable manner, e.g. by means of a screw thread, or may be fastened in a non-releasable manner, e.g. by soldering.

A metering and shut-off valve 20, which exhibits a valve seat member 22 with valve opening 24, is positioned at first end 14 inside extension unit 12. Between spray head 40 and thus between material discharge nozzle 42 and the valve seat member 22, is an intermediate space 44, inside which is valve body 26, at which tension-transmitting member 28 is attached. Tension-transmitting member 28 consists of flexible material and can, for example, be a rope and extends from valve body 26 through valve opening 24. The diameter of valve opening 24 is greater than the diameter of tension-transmitting member 28. Furthermore, the diameter of valve opening 24 is smaller than the largest diameter of valve body 26.

Tension-transmitting member 28 extends to the second end 16 of extension unit 12 and reaches into spraying device 1, where tension-transmitting member 28 is connected to actuator 2 of spraying device 1.

This actuator 2 is depicted schematically and exhibits a movable plunger 3, which interacts with spring device 4. Tension-transmitting member 28 is fastened to plunger 3.

FIG. 1a illustrates how valve body 26 is pushed against valve seat member 22 by means of spring device 4 interacting with tension-transmitting member 28 and held there. Consequently, valve opening 24 is closed by valve body 26. In this position, spray material cannot pass from extension unit 12 to spray head 40 through valve opening 24.

In order to open valve opening 24, plunger 3 is preferably moved back by means of compressed air against the force of spring device 4, whereby tension-transmitting member 28 is relieved. The pressure of the material pressed into extension unit 12 is sufficient to move valve body 26 into the open position (see FIG. 1b).

The material to be sprayed is introduced into extension unit 12 by spraying device 1 and flows in arrow direction through extension unit 12 to valve opening 24. The material pressed through valve opening 24 moves valve body 26 from valve seat member 22 in the direction of spray head 40, when tension-transmitting member 28 is relieving tension.

The material to be sprayed subsequently passes into intermediate space 44 and can be discharged by material discharge nozzle 42.

Valve seat member 22 is shaped like a cone and exhibits a first conical surface 23 on its inside. Valve body 26 exhibits a second conical surface 27, which is adapted to the first conical surface 23. The diameter of valve body 26 is smaller than the inside diameter of extension unit 12 shaped like a circular tube, so that sufficient space is available between valve body 26 and the tube's wall for spray material to pass.

By activating actuator 2, the tension-transmitting member can be retracted such that valve body 26 abuts first conical surface 23 of valve seat member 22 with its second conical surface 27 and thus closes valve opening 24. Depending on how far valve body 26 is pulled in the direction of valve opening 24 by means of actuator 2, material flow can be controlled by valve opening 24.

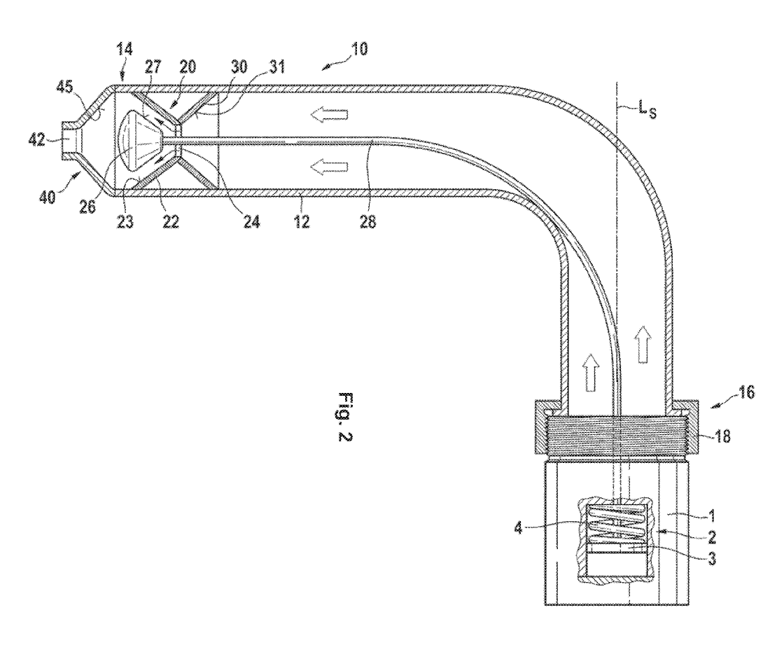

FIG. 2 depicts another embodiment, which illustrates a curved extension unit 12. The curvature, i.e. the deviation from the longitudinal axis L_{S} of spraying device 1, amounts to 90° in this embodiment. Since tension-transmitting member 28 is a flexible element, tension-transmitting member 28 adapts to extension unit 12's 90° curvature shown here. The way metering and shut-off valve 20 functions, is the same as in the embodiment of FIGS. 1a and b. Extension unit 12 may also exhibit several arbitrary curvatures. The length of the extension unit 12 may be several meters. Lengths up to 10 m are possible.

In addition, material guide element 30 is positioned at valve seat member 22, which is shaped cone-like in the embodiment shown here and has a conical inner surface 31.

Material guide element 30 tapers in the direction of valve opening 24, so that the incoming material is directed to valve opening 24. As a result, dead spaces in the area of valve seat member 22 are avoided, in which the material to be sprayed could dam up and deposit.

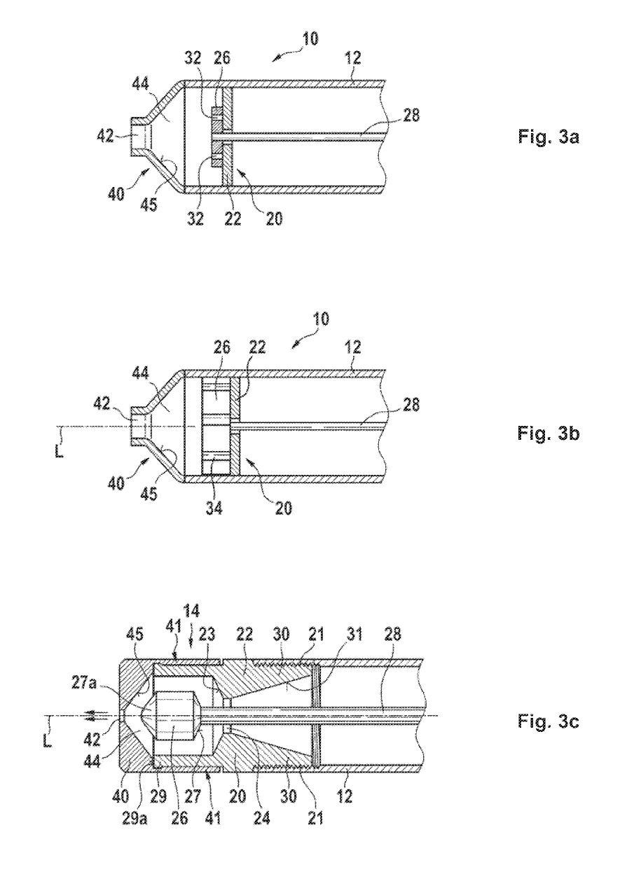

In FIG. 3a, another embodiment of the metering and shut-off valve 20 is illustrated. Valve seat member 22 is comprised of an annular disc and valve body 26 of a valve plate. In order to improve the material flow in the open position of metering and shut-off valve 20, the valve plate additionally exhibits holes 32.

FIG. 3b depicts another embodiment of the metering and shut-off valve 20, wherein the outer diameter of valve body 26 essentially corresponds to the inner diameter of extension unit 12, so that valve body 26 is guided by extension unit 12. In order to enable material flow in the direction of material discharge nozzle 42, valve body 26 has at its outer peripheral surface grooves 34, which extend parallel to longitudinal axis L of spray head 40.

Holes 32 and grooves 34 may also be combined in valve body 26.

FIG. 3c illustrates another embodiment, wherein metering and shut-off valve 30 is positioned at the first end 14 of extension unit 12. Spray head 40 is located at metering and shut-off valve 20.

Valve seat member 20 is connected in a detachable manner with extension unit 12, and spray head 40 is connected in a detachable manner with valve seat member 22. The combination of valve seat member 22 and extension unit 12 is, for example, accomplished by means of screw connection 21, whereas the connection between valve seat member 22 and spray head 40 is accomplished by means of a plug-in connection 41, or a clamping connection.

For this plug-in connection 41, a sleeve-like tube is positioned on spray head 40. Material guide element 30 exhibits a conical inner surface 31, whereby a cavity is formed, which tapers toward valve opening 24. Valve element 22 exhibits a first conical surface 23, which is adapted to the second conical surface 27 of valve body 26.

A sleeve-like section 29 attaches to the first conical surface 23, which extends in the direction of spray head 40.

Valve body 26 is shaped in a cylindrical manner and has a smaller diameter than the inner diameter of the sleeve-like section 29. At its end facing spray head 40, valve body 26 has a cone-like tip 27a with which valve body 26 extends into spray head 40 in its open position. Spray head 40 abuts the front surface 29a of sleeve-like section 29. A cone-like intermediate space 44 is formed between the conical inner surface 45 of spray head 40 and the cone-like tip 27a of valve body 26. Intermediate space 44 remains, even if valve body 26 is located at its maximum distance to conical surface 23.

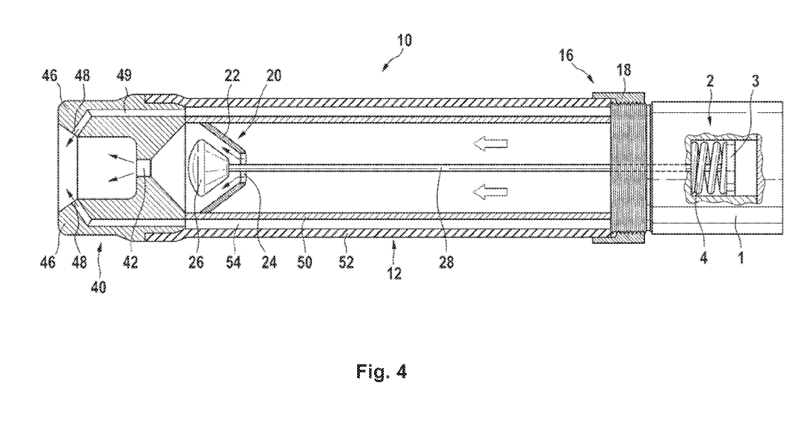

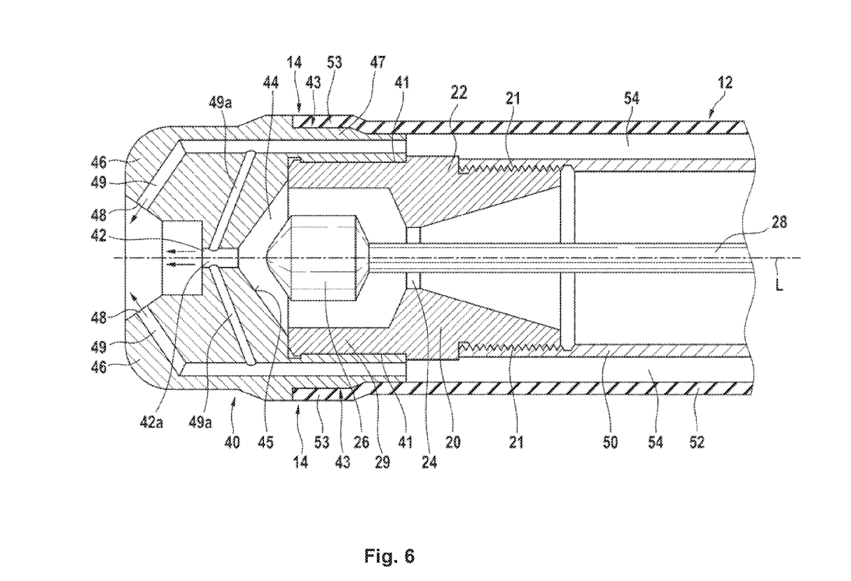

FIG. 4 illustrates another embodiment, in which extension unit 12 is designed with double walls. Extension unit 12 exhibits an inner wall 50 and an outer wall 52, whereby both walls are positioned spaced apart from each other such that between inner wall 50 and outer wall 52 a compressed air line 54 can be formed in the shape of an annular channel, as can be seen in the enlarged detail illustration of FIG. 6. Respective connections (not depicted) are provided in spraying device 1 in order to be able to introduce compressed air into this channel.

Outer wall 52 is preferably formed by a hose pushed over inner wall 50, which may consist of a metal tube.

Spray head 40 exhibits horns 46 with air nozzles 48. Compressed air line 54 is connected to these air nozzles 48 by means of air duct 49, so that forming a beam of spray material with different beam geometries can be accomplished.

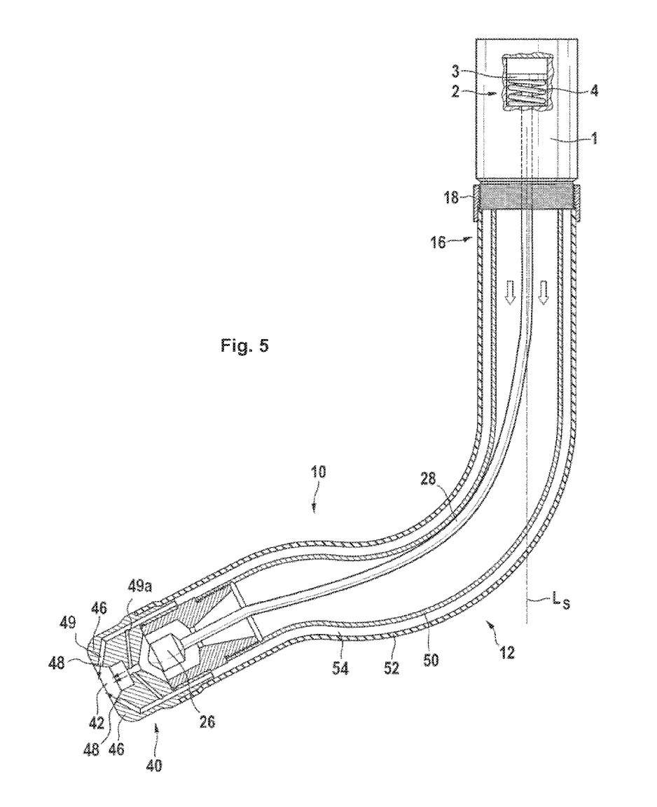

FIG. 5 illustrates another embodiment, in which extension unit 12 is also shaped with double walls and, in addition, exhibits two curvatures. The double-walled embodiment of extension unit 12 is shaped such that regardless of the curvatures, the inner wall 50 and outer wall 52 are always positioned spaced apart to each other, so that between the two walls compressed air line 54 can be formed in the shape of an annular and curved channel.

In this embodiment, spray head 40 also exhibits horns 46 with air nozzles 48. Compressed air line 54 is connected to these air nozzles 48, so that forming a beam of spray material with different beam geometries can be achieved.

FIG. 6 is a detailed illustration of the first end 14 of extension unit 12 shown in FIG. 5. Valve seat member 22 of the metering and shut-off valve 20, corresponding to the embodiment in FIG. 3c, is connected in a detachable manner to extension unit 12, and spray head 40 is connected in a detachable manner with valve seat member 22. Valve body 26 with tension-transmitting member 28 also corresponds to the embodiment of FIG. 3c. The connection of valve seat member 22 and extension unit 12 is again made by means of screw connection 21, whereas the connection between valve seat member 22 and spray head 40 is achieved by a simple plug-in and/or clamping connection 41.

With this embodiment as well, a sleeve-like section 47 is positioned on spray head 40 for the plug-in and/or clamping connection 41.

Spray head 40 exhibits two horns 46 with air nozzles 48, which are positioned in the direction of material flow behind the material discharge nozzle 42. Furthermore, extension unit 12 is designed with double walls, whereby the compressed air line 54 leads to spray head 40's air ducts 49, at whose ends are air nozzles 48. Air ducts 49a, which lead to material channel 42a, positioned ahead of material discharge nozzle 42, branch off from air ducts 49. Thus, forming a beam with different beam geometries can be achieved.

By means of clamping connection 43, outer wall 52 is connected in a detachable manner with spray head 40 and closes compressed air line 54 with an airtight seal. The sleeve-like section 47 is positioned between end section 53 of outer wall 52 and sleeve-like section 29 of valve element 22. The spray head exhibits a conical inner surface 45 similar to FIG. 3c.

### REFERENCE LIST

1 Spraying device
2 Actuator
3 Plunger
4 Spring device
10 Extension device
12 Extension unit
14 First end
16 Second end
18 Fastening devices
20 Metering and shut-off valve
21 Screw connection
22 Valve seat member
23 First conical surface
24 Valve opening
26 Valve body
27 Second conical surface
27a Tip
28 Tension-transmitting member
29 Sleeve-like section
29a Front surface
30 Material guide element
31 Inner surface
32 Hole
34 Groove
40 Spray head
41 Plug-in connection
42 Material discharge nozzle
42a Material channel
43 Clamping connection
44 Intermediate space
45 Inner surface
46 Horn
47 Sleeve-like section
48 Air nozzle
49 Air duct
49a Air duct
50 Inner wall
52 Outer wall
53 End section
54 Compressed air line
L Longitudinal axis
Lₛ Longitudinal axis of the spraying device

1. An extension device for spraying devices with an extension unit, comprising at a first end a spray head with at least one material outlet nozzle and having a second end configured to connect a spraying device, wherein the extension unit exhibits a metering and shut-off valve comprising a valve seat member with a valve opening and a valve body, that the valve body is positioned between the spray head and the valve seat member and that the valve body is fastened to a tension-transmitting member extending through the valve opening and that the tension-transmitting member consists of flexible material.

2. The extension device according to claim 1, wherein the metering and shut-off valve is positioned in or at the first end of extension unit.

3. The extension device according to claim 1, wherein the tension-transmitting member can be connected with an actuator, which is positioned in a spraying device.

4. The extension device according to claim 1, the wherein tension-transmitting member consists of a rope, cable, wire or a chain.

5. The extension device according to claim 1, wherein the extension unit is at least partially curved.

6. The extension device according to claim 1, wherein the valve seat member is an annular disc and the valve body is a valve plate.

7. The extension device according to claim 1, wherein the valve seat member and the valve body each exhibit a cone-like or frustoconical shape.

8. The extension device according to claim 7, wherein the valve seat member exhibits a first conical surface and the valve body a second conical surface, and wherein the valve body in its closed position comes into contact with the second conical surface at the first conical surface.

9. The extension device according to claim 1, wherein the valve body exhibits at least one hole and/or at least one groove.

10. The extension device according to claim 1, wherein a material guide element is positioned in front of the valve opening in the flow direction of the spray material.

11. The extension device according to claim 1, wherein at least one compressed air line is provided.

12. The extension device according to claim 1, wherein the extension unit exhibits an inner wall and an outer wall.

13. The extension device according to claim 12, wherein the inner wall and the outer wall are positioned at least partially spaced apart to form the compressed air line.

14. The extension device according to claim 12, wherein the outer wall is a hose.

15. The extension device according to claim 11, wherein the spray head exhibits at least one air nozzle, which is connected to the compressed air line.

16. (canceled)

17. (canceled)

18. (canceled)

19. The extension device according to claim 2, wherein the tension-transmitting member can be connected with an actuator, which is positioned in a spraying device, and wherein tension-transmitting member consists of a rope, cable, wire or a chain.

20. The extension device according to claim 19, wherein a material guide element is positioned in front of the valve opening in the flow direction of the spray material.

21. A spraying device to spray material onto surfaces with an extension device, with the extension device comprising an extension unit and having at a first end a spray head with at least one material outlet nozzle and having a second end configured to connecting a spraying device, wherein the extension unit exhibits a metering and shut-off valve comprising a valve seat member with a valve opening and a valve body, that the valve body is positioned between the spray head and the valve seat member and that the valve body is fastened to a tension-transmitting member extending through the valve opening and that the tension-transmitting member consists of flexible material.

22. The spraying device of claim 21, wherein the tension-transmitting member is connected with an actuator of the spraying device.

23. The spraying device of claim 21, wherein the actuator exhibits a movable piston and a spring element.
